(19) United States
(12) Patent Application Publication
(10) Pub. No.: US 2017/0006856 A1
(43) Pub. Date: Jan. 12, 2017

(54) DECOY ASSEMBLIES

(71) Applicants: Claudio Ongaro, Edmonton (CA); Jackie Jackson, Calgary (CA)

(72) Inventors: Claudio ONGARO, Edmonton (CA); Jason BAMFORD, Edmonton (CA)

(73) Assignees: Jackie Jackson, Calgary (CA); Claudio Ongaro, Edmonton (CA)

(21) Appl. No.: 14/796,822

(22) Filed: Jul. 10, 2015

(51) Int. Cl. A01M 31/06

(52) U.S. Cl. CPC A01M 31/06; A01M 2200/00

(57) ABSTRACT

Decoy assemblies are disclosed. A decoy is printed on a base, self-standing structure that holds the decoys out without staking Decoy assemblies include reconfigurable interconnected hinged sheet systems configured to fold and deploy in a fanned out or accordion fashion. Decoy assemblies include a photographic image printed on a Y-board in some cases.

### TECHNICAL FIELD

This document relates to decoy assemblies and related methods of use.

### BACKGROUND

Y-board decoys, also known as V-boards, have three arms that each mount a decoy without staking Y-boards use a relatively heavy wood or metal base for mounting the decoys. Lateral stability is achieved by providing wide low profile arms, arm locking mechanisms, or a wide center block to mount the arms. The use of Y-boards declined over the latter half of the 20^{th} century in favor of individual stakable decoys.

### SUMMARY

Decoy assemblies are disclosed. A decoy is printed on a base, self-standing structure that holds the decoys out without staking Decoy assemblies include reconfigurable interconnected hinged sheet systems configured to fold and deploy in a fanned out or accordion fashion. Decoy assemblies include a photographic image printed on a Y-board in some cases.

A decoy assembly is disclosed comprising: three or more arms each formed of a sheet having a ground engaging edge; the arms being interconnected by hinges and moveable about the hinges between a closed position and a deployed position where the arms fan out to laterally stabilize one another while standing upright on the ground engaging edges; each arm having a scenery image covering the visual surfaces of opposed side walls of the arm, the scenery image including an animal image at a decoy part of the arm.

A decoy assembly is also disclosed comprising: three or more arms each formed of a sheet having a ground engaging edge; the arms being interconnected by living hinges and moveable about the living hinges between a closed position and a deployed position where the arms fan out to laterally stabilize one another while standing upright on the ground engaging edges; and each arm forming a decoy part with an animal image on opposed side walls of the arm.

A decoy assembly is also disclosed comprising: three or more arms each formed of a sheet having a ground engaging edge and a structural frame that is made of plastic and formed by opposed walls bridged by a low-density reinforcing core; the arms being interconnected by hinges and moveable about the hinges between a closed position and a deployed position where the arms fan out to laterally stabilize one another while standing upright on the ground engaging edges; and each arm forming a decoy part with an animal image on opposed side walls of the arm.

An assembly comprising: three or more arms each formed of a sheet having a ground engaging edge; the arms being interconnected by hinges and moveable about the hinges between a closed position and a deployed position where the arms fan out to laterally stabilize one another while standing upright on the ground engaging edges; and each arm having a decorative image covering the visual surfaces of opposed side walls of the arm; and the top and side edges of each arm being shaped to conform to the silhouette of an object or animal in the decorative image.

Methods of use and assembly of decoy assemblies are disclosed. A printed sheet of material is disclosed containing in uncut form the arms, and in some cases other components, of the decoy assemblies. The printed sheet may be cut and assembled to form a decoy assembly. Decoy assemblies may be deployed in a particular configuration and hunting operations commenced.

In various embodiments, there may be included any one or more of the following features: The hinges are living hinges. Each hinge is formed on a connector sheet between adjacent arms. Each connector sheet has opposed hinge leaves, with each hinge leave having a ground engaging edge and forming a reinforcing layer upon a portion of a side wall of a respective sheet forming the adjacent arms. A hinge animal part with one or more animal images that cover portions of the side walls of adjacent arms to give the appearance of an animal extended across a respective hinge between adjacent arms. The one or more animal images of the hinge animal part is of a crouching, sitting, or nesting animal. The three or more arms form a Y-shape in the deployed position. At least one arm forms a ground engaging base that laterally spaces the decoy part from a respective hinge that connects the arm to an adjacent arm, the scenery image including a ground cover image on the ground engaging base. The top and side edges of each decoy part are shaped to conform to the silhouette of the animal image. The scenery images are photographic images. Each sheet has a structural frame that is made of plastic and formed by opposed walls bridged by a low-density reinforcing core. The low-density reinforcing core comprises a plurality of hollow channels whose central axes are perpendicular to the opposed walls. The arms are moveable between a range of deployed positions. The animal image is of a bird. Each arm has a slot or hole, and the slots or holes collectively align between arms when in the closed position. The three or more arms comprise a first arm, a second arm, and a third arm; a side end of the first arm connects to a first side end of the second arm; a side end of the third arm connects to the first side end of the second arm; and the three or more arms form a Y-shape when in the deployed position as viewed from above. Hinges whose respective hinge axes are perpendicular to a ground plane defined by the ground engaging edges of the three or more arms. Plural decoy animals are displayed on one or more of the sheets. Each sheet has a maximum thickness of less than or equal to 1 centimeter. The images display decoy animals in different positions. Decoy assemblies whose arms form a Z, C, or W shape when in the deployed position.

These and other aspects of the device and method are set out in the claims, which are incorporated here by reference.

### BRIEF DESCRIPTION OF THE FIGURES

Embodiments will now be described with reference to the figures, in which like reference characters denote like elements, by way of example, and in which:

FIG. 1A is a perspective view of a decoy assembly whose arms form a Y-shape in the deployed position shown.

FIG. 1B is a perspective cut away from of a part of a sheet that forms an arm of the assembly of FIG. 1A.

FIGS. 2 and 3 are top plan views of the hinge portion of the decoy assembly of FIG. 1A shown in the stacked and deployed positions, respectively.

FIG. 4 is a side elevation view showing a method of connecting the front sheets shown in the decoy assembly of FIG. 1A.

FIG. 5 is a side elevation view showing a method of connecting the sheets shown on the left in the decoy assembly of FIG. 1A.

FIG. 6 is a top plan view of a sheet of material showing the printed layout of the component parts of the decoy assembly of FIG. 1A.

FIG. 7 is a top plan view of a cut pattern to be used with the sheet of material from FIG. 6, with bend lines shown in dashed lines.

FIG. 8 is a perspective view of the shape of a decoy assembly in a deployed position and whose arms form a Z-shape.

### DETAILED DESCRIPTION

Immaterial modifications may be made to the embodiments described here without departing from what is covered by the claims.

A hunting decoy is a type of device that has been used for centuries in order to attract game to a particular location. Forms of decoys include representations of the creature being hunted. Decoys may be made with life-size proportions. A hunter places a number of decoys about the hunting area in order to encourage game such as wild birds to land nearby within the range of the concealed hunter's gun.

Decoys are one of the items used by almost all fowl hunters, such other items including a shotgun, ammunition, a hunting blind, and a duck or goose call. The decoys are used to lure the birds within range and the blind conceals the hunter. When a hunter or hunters sees the fowl, he or she may call the duck or goose as may be relevant to the type of birds being lured. Once the birds are within range, the hunters rise from the blind and quickly shoot the birds before they are frightened off and out of shooting range. Duck or goose calls are often used to attract birds. Sometimes calls of other birds will also be simulated to convince the birds that there is no danger.

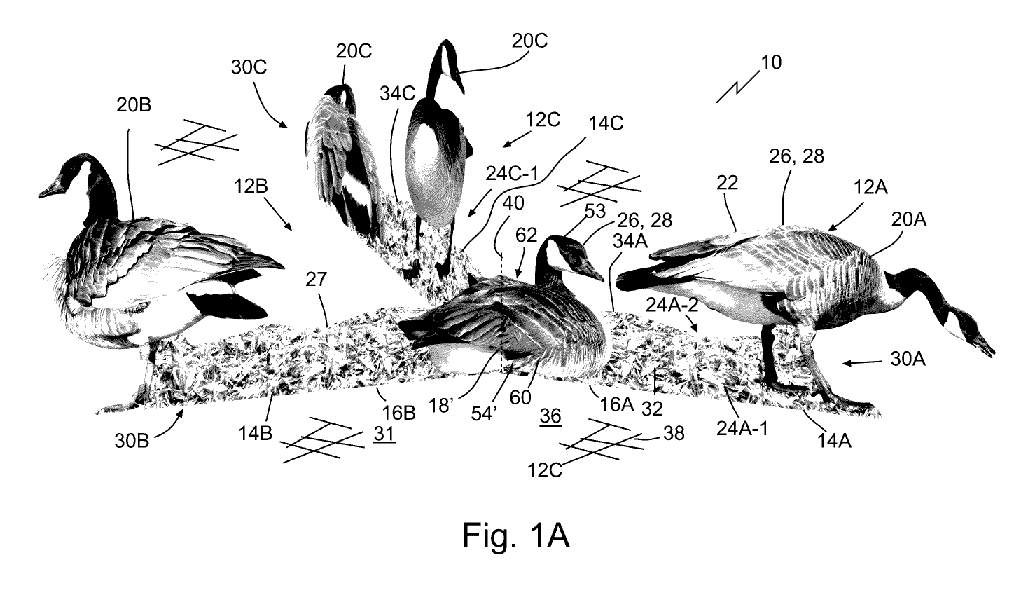

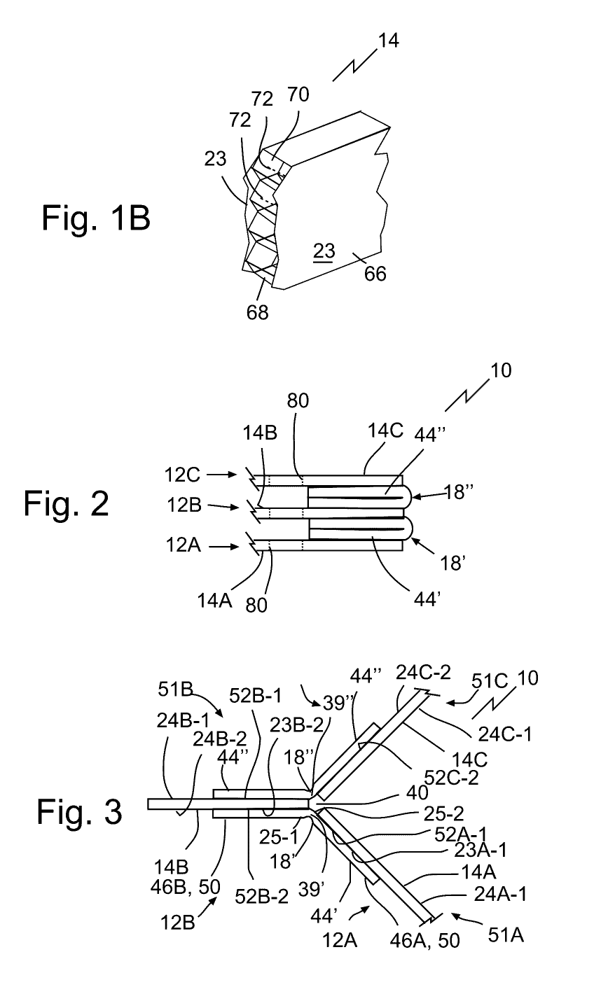

Referring to FIG. 1A, a decoy assembly 10 is illustrated comprising three or more arms 12. Referring to FIGS. 1A-5 each arm 12 is formed of a sheet 14. Referring to FIG. 1A each sheet 14 has a ground engaging edge 16, upon which the respective arm 12 stands upright from when deployed. Referring to FIGS. 2 and 3, the arms 12 are interconnected by hinges 18 and moveable about the hinges 18 between a closed position (FIG. 2) and a deployed position (FIGS. 1A and 3) where the arms 12 fan out to laterally stabilize one another. Laterally stabilize may mean stabilize against forces applied normal to the side walls 24 of an arm 12. In the closed position arms 12 may be stacked together with the side walls 24 of adjacent arms 12 facing one another. In the deployed position the arms 12 may be spread apart from one another to collectively form a free standing base resting upon the ground engaging edges 16 without penetrating a ground surface 36. Three arms interconnected in such a fashion provide a stable base structure and make decoys visible from all angles around the assembly 10. Arms formed of a sheet and hinged together may form upright structures that are able to wave and move in the wind, thus creating a life-like appearance of movement.

In the drawings, reference numerals for the arms 12, sheets 14, and related components may have a suffix A, B, or C appended to associate the reference numeral with a respective arm or sheet, even if the suffix is not explicitly used in the specification, or the generic reference numeral not explicitly used in the drawing. Similarly, in the drawings reference numerals for the hinges, and related components may have a suffix ′ or ″ appended to associate the reference numeral with a hinge 18′ between arms 12A and 12B, or a hinge 18″ between arms 12B and 12C, even if the suffix is not explicitly identified in the specification, or the generic reference numeral not explicitly used in the drawing.

Referring to FIG. 1A, each arm 12 forms a decoy part 20 having an animal image 22, for example of a bird such as a Canada goose as shown, over opposed side walls 24 of the arm 12. The reference numerals for side walls may be referred to in the drawings and specification with the additional suffixes −1 and −2, in some cases appended to the suffixes A, B, and C, to refer to different side walls, see FIG. 3 for example. The top and side edges 26 of each decoy part 20 may be shaped to conform to the silhouette 28 of the animal image 22, to provide for a realistic appearance of the animal from different angles and from the perspective of a moving animal. In some cases the image on one side wall 24-1 may be the mirror image of the image on the opposed side wall 24-2 to ensure that the silhouettes 28 on the opposed side walls 24 align.

Referring to FIG. 1A, each arm 12 may have a scenery image 30, such as the dynamic photographic image as shown, covering the visual surfaces of opposed side walls 24 of the arm 12. Covering the visual surfaces means that all externally viewable surfaces of the arm 12, including layered portions but excluding sheet edges, are printed upon with the scenery image 30. A scenery image may include features and animals of a natural landscape. The scenery image 30 includes the animal image 22, which may form part of a greater scenery image 30 that includes a ground cover image 32. A photographic image is one that is composed of one or more images of naturally appearing scenery, ground cover (camouflage), and animals for a realistic representation of same on the arms 12. Because the image 30 covers the visual surfaces, each arm 12 has the appearance from afar of forming part of the adjacent environment, when placed in an environment 31 that matches or blends with the scenery image, without unnatural parts such as single color or blank faces, which contrast with an external environment and may deter animals from approaching. The scenery image may be dynamic, which means that the image shown on each part is constantly changing across the part, as contrasted with the use of block color images.

At least one arm 12, for example each of arms 12A-C in FIG. 1A, may form a ground engaging base 34 that lies upon ground engaging edges 16 along a ground surface 36. The base 34 may laterally space the decoy part 20 from a respective hinge 18 that connects the arm 12 to an adjacent arm 12. The scenery image 30 may include a ground cover image 32 along the elongate base arm part 34, for example ground cover 38 matching same in the environment 31 that the assembly 10 is deployed in. The example assembly 10 shown is selected to match a harvested corn field in fall. Other ground cover images may be of various grasses. Durham wheat, barley, corn, hay, snow, woodland, and other ground covers may be used. The ground engaging base 34 may itself form an arm or branch part that extends from hinge 18′ between the hinge 18′ and the decoy part 20, thus providing separation between decoy parts 20A, 20B, and 20C, to give a natural appearance of a group of animals. The separation distance between animals in the deployed position may be selected to be commensurate with a natural average separation distance between the animals in real life groups. One or more arms 12 may have plural decoy parts, such as parts 20C on arm 12C (FIG. 1A). The ground engaging edge 16 of each base 34 may extend continuously along the lateral length of the arm 12. Each decoy part 20 may project vertically above the ground hugging base 34, for example if the animal is shown standing. A low profile base 34 minimizes the casting of unnatural shadows that may deter animals. A top edge 27 of the base 34 may have an undulating or other non-straight profile.

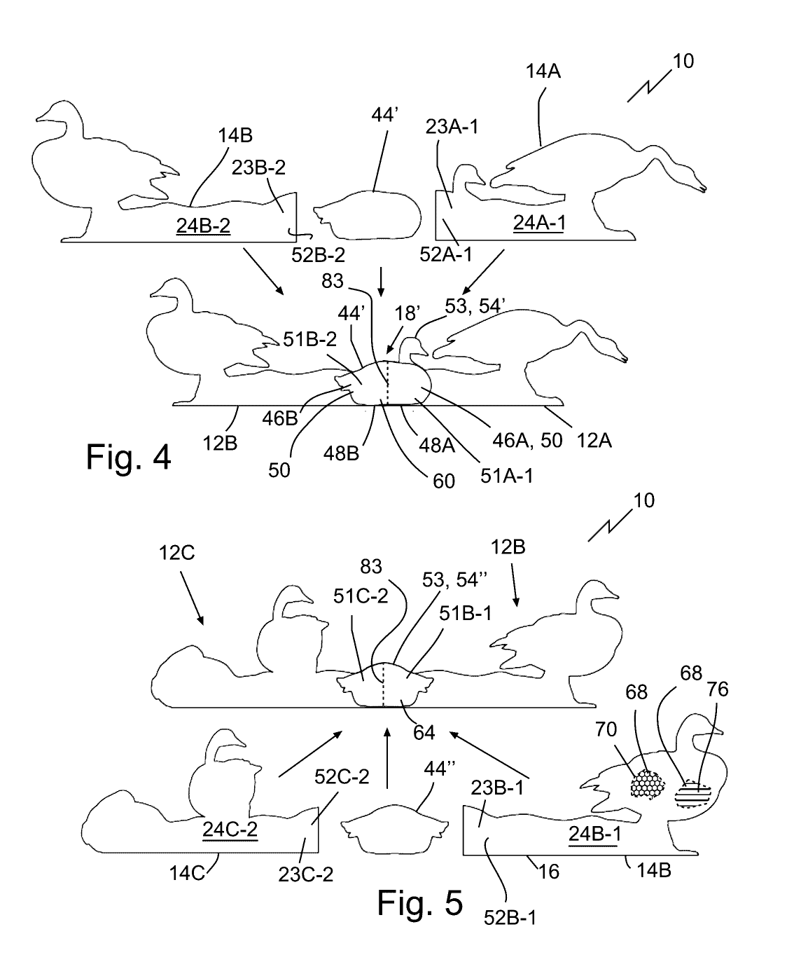

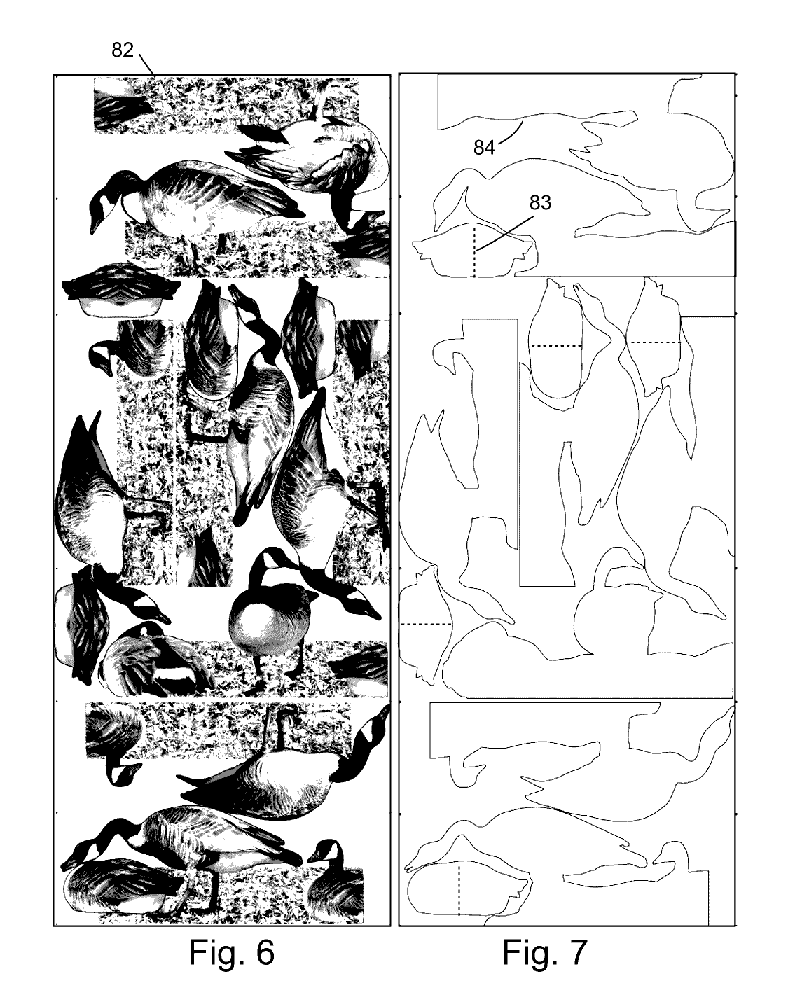

Referring to FIGS. 1A-3 at least one of the hinges 18′ and 18″may be living hinges as shown. A living hinge 18 is made from a single continuous piece of material that has a hinge line that defines opposed hinge leaves. A living hinge may be a thin flexible hinge such as a flexure bearing. Referring to FIGS. 2 and 3, each living hingel8 may be formed on a connector sheet 44 between adjacent arms 12. Referring to FIG. 3 the vertical hinge 18 may be thinned, for example by one or more of crushing as shown, or selectively cutting or scoring, for example cutting an inner side wall 25-2 of opposed side walls 25 of the connector sheet 44 and possibly core material 68 (FIG. 5) leaving the outer side wall 25-1 intact, to allow the adjacent rigid pieces to bend along the line 39 of the hinge 18. A living hinge has a relatively low cost compared to other hinges, and permits the hinge 18 to have scenery image 30 printed upon the connector sheet 44 and cut from the same blank of material used to print the sheets 14 (FIGS. 6 and 7). Referring to FIGS. 3 and 4, each connector sheet, such as connector sheet 44′, may have opposed hinge leaves 46. Referring to FIG. 4, hinge leaves 46 may each have a ground engaging edge 48. Referring to FIGS. 3 and 4, hinge leaves 46 may form reinforcing layers 50 upon portions, such as lateral end portions 52, of adjacent side walls 23, in this case 23A-1 and 23B-2, of respective sheets 14 forming arms 12. Hinge leaves 46 may be connected to adjacent components by suitable methods such as adhesives, staples, bonding, two or one sided tape, or fasteners.

Hinge leaves 46 may be formed from one or more adjacent arms 12. Thus, in some cases (not shown), a single continuous sheet may form two or more of arms 12 delineated by living hinges 18 in the sheet 14. In other cases (not shown), one sheet 14 may be bent at end 52 to form a living hinge, with the outermost hinge leave forming a reinforcing layer on the adjacent arm 12. However, relative to such examples the use of connector sheets 44 add reinforcement and lateral stability to the hinge structure and hence the decoy assembly 10 as a whole. Using connector sheets 44 to connect lateral ends of sheets 14 together also reduces the lateral length required for each sheet 14, thus permitting printing on relatively narrower sheets. Images may be printed directly on the living hinge to provide a continuous image.

Referring to FIGS. 1A, 4 and 5, decoy assembly 10 may have a hinge animal part 53 with one or more animal images 54 that cover portions, such as respective lateral end portions 52 (FIGS. 4 and 5) of the side walls 23 of adjacent sheets 14 to give the appearance of an animal extended across a respective hinge 18 between adjacent arms 12. The animal image or images 54 of the hinge animal part 53 may be of a crouching, sitting, or nesting animal as shown, in order to provide a relatively low vertical profile but stable hinge base as shown. Displaying an animal at the hinge point also permits a relatively higher vertical wall height at the hinge than if no hinge animal is used, without sacrificing and in some cases enhancing realism at the arm transition. In the example shown, three distinct animal images are used for hinge animal part 53—a first side image 60 appears across side walls 24A-1 and 24B-2 (FIGS. 1A and 4), a mirror image 62 of the first side image 60 appears across side walls 24A-2 and 24C-1 (FIG. 1A but not directly shown), and a third image 64 being a rear image of the animal, for example made up of the rear halves of the images 60 and 62, appears across sides walls 24B-1 and 24C-2 (FIG. 5). Referring to FIG. 1A the top and side edges 26 of the hinge animal part 53 may be shaped to conform to the silhouette 28 of the animal images 60, 62, and 64 as shown, to allow the animal image to project out of the greater image for a three dimensional effect.

Referring to FIG. 3, the three or more arms 12 may form a Y-shape in the deployed position. Thus, a Y-board may be provided as viewed from above and that is made of sheets 14 standing upright on edges 16. One way to assemble a Y-shape assembly 10 is as follows. A side end, such as lateral end portion 51A, of a first arm 12A connects by hinge 18′ to a first side end, specifically lateral end portion 51B of a second arm 12B. A side end such as portion 51C of a third arm 12C connects to the first side end, specifically portion 51B, of the second arm 12B. In the example shown the hinges 18′ and 18″ share a common hinge axis 40, for example a vertical axis or axis perpendicular to a ground plane (not shown) defined by the ground engaging edges 16 as shown, about which the arms 12 radially spread out in the deployed position or positions.

In the example shown each arm 12 is moveable between a range of deployed positions. Two or more of the arms 12, in this case all three arms 12, may each form free or terminal ends whose pivotal movement is governed by a single hinge axis and that are unrestrained by arm configuration locking mechanisms in use. Thus, a user may select one of a variety of configurations to use while deployed. In a Y-board example one configuration involves having the arms 12 spread apart at one 120 degree angles. In the Y-board example, with at least one decoy part on each arm 12, at least two of the three decoys are visible from any location 360 degrees around the assembly 10.

Referring to FIG. 1B, each planar sheet 14 may have a structural frame 66 that is made of plastic. Structural frame 66 may be formed by opposed walls 23, and a low-density reinforcing core 68. Core 68 bridges the opposed walls 23, for example-by being made up of components that add lateral stability to the structural frame 66. Example of lateral stabilizers include a corrugated sheet, ribs, or a low-density gas or air containing bridging structure such as a foam. In the example shown the low-density reinforcing core 68 comprises a plurality of hollow channels 70 whose central axes 72 are perpendicular to the faces of the opposed walls 23. Referring to FIGS. 1B and 5, each channel 70 may have a polygonal cross sectional shape such as a honeycomb pattern as shown, for example if each printed substrate 14 is made from a STINGER™ sheet. In other cases such as shown in the example in FIG. 5, the lateral stabilizers may be ribs or flutes 76 for example running parallel to the side walls 23, for further example running perpendicular (vertical) or parallel (horizontal) to the ground engaging edge 16. Horizontal flutes have been found to have greater lateral stability than vertical flutes.

Suitable corrugated plastic or other reinforced plastic sheets may be used, for example those marketed as COROPLAST™, POLYFLUTE™, FLUTEPLAST™, INTEPRO™, PROPLEX™, CORREX™, TWINPLAST™, SINTRA™, COMATEX™, and INTACELL™. Corrugated plastic refers to a wide range of extruded twin wall plastic-sheet products produced from high-impact polypropylene resin with a similar structure as corrugated paper. Such materials are light-weight, rigid, tough materials that bend without breakage of side walls, and can easily be cut with a utility knife. Bendability is believed to stem from the use of flexible components that make up the structural frame, with the resulting frame providing sufficient rigidity to stand upright in the deployed position, while retaining the ability to bend up to 180 degrees without breaking the side walls. Suitable materials may be made from polymers such as polypropylene, polyethylene, polyvinyl chloride (PVC), polycarbonate, plastic laminated foam board, and polystyrene. In some cases the selected material may be one that is resistant to work hardening, such as certain sufficiently elastic materials, such as polypropylene copolymers or polyethylenes, thus forming a rigid durable living hinge that retains ductility despite continual bending. For example, the material may be selected to be able to be moved, from an open position to a closed position of 180 degrees bend and back to the open position, more than 350 times without breakage. A decoy assembly 10 may be closed and opened 30-60 times a year, and in environments of ambient temperatures of minus 20 degrees Celsius and lower. The sheet material 12 used may be too thin to stand up on edge without external lateral stabilization.

In some cases sheets 14 may have a thickness of between 5 and 10 mm, for example 5 mm STINGER™ plastic board. Sheets 14 may have a density of less than or equal to 2 kg/m². Density may be below that of water to permit floating. Ground engaging bases 34 may have a minimum height of 12 cm to ensure sufficient strength to retain stability in wind. In some cases each arm may have a minimum base 34 height to decoy part 20 height of 1:4. Arms 12 may extend up to 1 m or more in a lateral direction. Each sheet 14 may have an integral, continuous structure extending the lateral length of the arm 12. Side walls 23 and lateral stabilizers in the core 68 may have individual thicknesses of less than or equal to 3 mm. Each sheet 14 may have a lateral length of up to and greater than 100 cm.

Referring to FIG. 2, two or more, for example all, arms 12 may have a slot or hole 80 (shown in dashed lines). The slots or holes 80 may be positioned to collectively align between arms 12 when in the closed position. Aligned slots or holes 80 may thus provide a common handle to fit a user's hand or portion of a hand for carrying purposes in the closed position, or may provide a point from which the assembly can be hung by a hook (not shown) in the closed position. The slots or holes may be positioned at or near a center of gravity of the assembly when in the closed position.

Referring to FIGS. 6 and 7 the components of the decoy assembly 10 may be printed on a blank of material 82 (FIG. 6), cut out according to a cut sheet pattern 84 (FIG. 7), and assembled. Printing may be carried out using a suitable printer, such as an AGFA™ or TORO™ flatbed ink printer. Printing may be carried out using a UV-resistant, antiglare ink. Printing may include printing a primer or underlayer such as a white layer on a black sheet, followed by printing the desired image upon the white layer for brighter color in the final image.

Referring to FIG. 6, once printed the sheet of material 82 contains in uncut form the three or more legs of the decoy assemblies of any one of claims 1-17. In the example shown the sheet of material 82 has printed sufficient components to assembly more than two assemblies 10. The arrangement of components about the material 82 may be selected to maximize space usage and minimize wasted space. Components may be cut along pre-programmed cut lines by a suitable cutting machine, such as an oscillating cutting machine such as the ZUND G3™ machine. For example one suitable machine has an infrared camera that reads dots patterned on the sheet of material 82 during printing, the dots being registered on the material 82 according to the cut sheet pattern shown in FIG. 7, and the cutting machine reads the dots, and cuts out each component efficiently and automatically. Other cutters may be used such as a laser cutter used in CNC processes. The method of assembly may include bending the components as required to produce the hinges 18. Bending may be carried out prior to, during, or after cutting. Bends may be introduced by crushing material 82 along pre-programmed bend lines 83 (FIGS. 4, 5, 7), for example using a die cutter set to low pressure. Scoring may be carried out in addition to or instead of bending and folding processes.

Once components are printed, for example on both sides of material 82, and cut out, the decoy assembly 10 may be assembled. For example, arms 12 and connector sheets 44 may be connected together, using a suitable adhesive. Connection may be carried out to an extent sufficient to permanently affix the components together such that separation is not possible without damaging the components. For example a two part adhesive may be used, such as a bonding epoxy made by JB WELD™. One suitable epoxy is known as PL400™.

Referring to FIG. 1A, once assembled, decoy assembly 10 may be used by fanning out arms 12 from the closed position into a deployed position as shown. After deployment the assembly 10 may be left on the ground 36, and a hunter may carry out hunting operations adjacent the deployed decoy. To pack up the assembly 10, a hunter need only swing arms 12 back into the closed position (FIG. 2), and stack the assembly 10 with other assemblies in a vehicle for transport away from the hunting site. Assembly 10 may be stored, for example on the wall of a garage, by leaning the closed assembly 10 against the wall or by hanging from a hook as discussed elsewhere in this document.

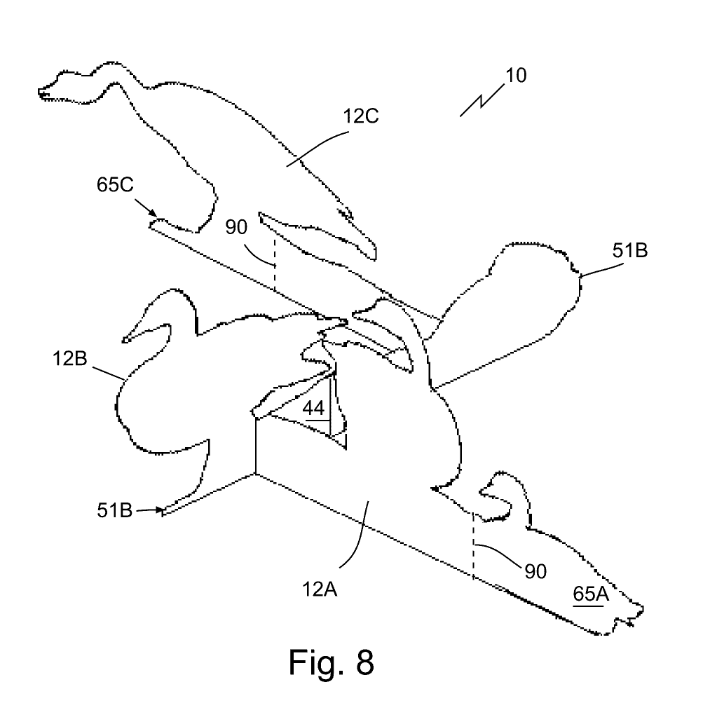

Referring to FIG. 8, an alternative embodiment is illustrated whose arms 12 form a Z-shape when in the deployed position. As shown, at least one arm 12B may connect to two or more other arms 12A, 12C at different lateral positions along the length of the arm 12B. Arms 12A and 12C are shown connecting to arm 12B at intermediate lateral positions 92 spaced from lateral ends 51B of arm 12B, in order to avoid the occurrence of a relatively unnatural vertical terminal edge corner between adjacent sheets 14, though such is not required. Other shapes are possible for arms 12, including more complex articulating or accordion style shapes such as a W-shape, as well as shapes that incorporate both Z and Y shaped sections. C-shaped sections are possible. Additional hinge bends 90 may be present to permit folding of lateral free lateral end portions 65A and 65C to permit more compact stacking in the closed position.

In some cases one or more arms lack a decoy part. Ground engaging base 34 may include nominal non-ground engaging parts. Undulating includes an edge profile with sharp corners. In examples where the top and side edges conform to a silhouette, the conforming edges may include downwardly oriented edges, including base edges, and some edges may define a lateral hole in the sheet 14. In some cases, a decal or graphic wrap may be printed and applied to the surface of material 82 prior to cutting or wraps may be applied to each individual component after cutting. Screen printing may also be used. Components may be manually cut with hand tools from sheet of material 82.

Decoy assemblies 10 may be used with floats, and in such cases may have a lock to retain the desired deployed configuration. Each sheet may comprise two or more sheets layered together for reinforcement. Each image printed on opposed side walls may be a front and back image of the same scene or animal, or a mirror image. Connector sheets 44 need not be formed of identical material as arms 12 but may be of the same class of material. Each arm 12 may have display different images from other arms to give a more natural dynamic look to the decoy assembly 10.

Hinges 18 may have a zero displacement angle in the closed position, and an angle of between but not including 0 and 180 degrees in the deployed position. The entire image on an arm 12 may be of a decoy animal or animals. The animal shown in the image may be a bird, coyote, wolf, moose, deer, or other animal. Each ground engaging edge 16 may be straight from lateral end to lateral end. In some cases the entire ground engaging element of the assembly 10 consists of vertical boards stood on edge. A decoy part 20 may be located at a lateral end of arm 12 opposite a hinge lateral end. The assemblies 10 may withstand up to and above 30 kilometer per hour winds. The sheets 14 may be waterproof, lightweight, durable and portable. Non-living hinges 18 may be used such as pivot pins, door hinges, and other such hinges. Y-board embodiments may be deployed in a T-shape position. Decoy assemblies may have two, three, four, or more arms.

Although decoy assemblies are shown in the drawings, other decorative assemblies may be used, such as one whose arms detail a Christmas image, for example including a decorative image with snowy ground cover and an image of a sleigh, reindeer, or snowman.

In the claims, the word “comprising” is used in its inclusive sense and does not exclude other elements being present. The indefinite articles “a” and “an” before a claim feature do not exclude more than one of the feature being present. Each one of the individual features described here may be used in one or more embodiments and is not, by virtue only of being described here, to be construed as essential to all embodiments as defined by the claims.

The embodiments of the invention in which an exclusive property or privilege is claimed are defined as follows:

1. A decoy assembly comprising:
three or more arms each formed of a sheet having a ground engaging edge;
the arms being interconnected by hinges and moveable about the hinges between a closed position and a deployed position where the arms fan out to laterally stabilize one another while standing upright on the ground engaging edges; and
each arm having a scenery image covering the visual surfaces of opposed side walls of the arm, the scenery image including an animal image at a decoy part of the arm.

2. The decoy assembly of claim 1 in which the hinges are living hinges.

3. The decoy assembly of claim 2 in which each living hinge is formed on a connector sheet between adjacent arms.

4. The decoy assembly of claim 3 in which each connector sheet has opposed hinge leaves, with each hinge leave having a ground engaging edge and forming a reinforcing layer upon a portion of a side wall of a respective sheet forming the adjacent arms.

5. The decoy assembly of claim 1 further comprising a hinge animal part with one or more animal images that cover portions of the side walls of adjacent arms to give the appearance of an animal extended across a respective hinge between adjacent arms.

6. The decoy assembly of claim 5 in which the one or more animal images of the hinge animal part is of a crouching, sitting, or nesting animal.

7. The decoy assembly of claim 1 in which the three or more arms form a Y-shape in the deployed position.

8. The decoy assembly of claim 1 in which at least one arm forms a ground engaging base that laterally spaces the decoy part from a respective hinge that connects the arm to an adjacent arm, the scenery image including a ground cover image on the ground engaging base.

9. The decoy assembly of claim 1 in which the top and side edges of each decoy part are shaped to conform to the silhouette of the animal image.

10. The decoy assembly of claim 1 in which the scenery images are photographic images.

11. The decoy assembly of claim 1 in which each sheet has a structural frame that is made of plastic and formed by opposed walls bridged by a low-density reinforcing core.

12. The decoy assembly of claim 11 in which the low-density reinforcing core comprises a plurality of hollow channels whose central axes are perpendicular to the opposed walls.

13. The decoy assembly of claim 1 in which the arms are moveable between a range of deployed positions.

14. The decoy assembly of claim 1 in which the animal image is of a bird.

15. The decoy assembly of claim 1 in which each arm has a slot or hole, and the slots or holes collectively align between arms when in the closed position.

16. A decoy assembly comprising:
three or more arms each formed of a sheet having a ground engaging edge;
the arms being interconnected by living hinges and moveable about the living hinges between a closed position and a deployed position where the arms fan out to laterally stabilize one another while standing upright on the ground engaging edges; and
each arm forming a decoy part with an animal image on opposed side walls of the arm.

17. A decoy assembly comprising:
three or more arms each formed of a sheet having a ground engaging edge and a structural frame that is made of plastic and formed by opposed walls bridged by a low-density reinforcing core;
the arms being interconnected by hinges and moveable about the hinges between a closed position and a deployed position where the arms fan out to laterally stabilize one another while standing upright on the ground engaging edges; and
each arm forming a decoy part with an animal image on opposed side walls of the arm.
